(19) United States
(12) Patent Application Publication
(10) Pub. No.: US 2011/0137920 A1
(43) Pub. Date: Jun. 9, 2011

(54) METHOD OF MAPPING SONGS BEING LISTENED TO AT A GIVEN LOCATION, AND ADDITIONAL APPLICATIONS ASSOCIATED WITH SYNCHRONIZED LYRICS OR SUBTITLES

(75) Inventors: Ran Cohen, Tel Aviv (IL); Amnon Sarig, Woodland Hills, CA (US); Gabby Rubin, Sunnyville, CA (US)

(73) Assignee: TUNEWIKI LTD, Road Town, Tortola (VG)

(21) Appl. No.: 13/026,316

(22) Filed: Feb. 14, 2011

Related U.S. Application Data
(63) Continuation-in-part of application No. PCT/IL09/00804, filed on Aug. 13, 2009.
(60) Provisional application No. 61/088,727, filed on Aug. 14, 2008.
(60) Provisional application No. 61/094,954, filed on Sep. 7, 2008.
(60) Provisional application No. 61/152,368, filed on Feb. 13, 2009.
(60) Provisional application No. 61/166,743, filed on Apr. 5, 2009.
(60) Provisional application No. 61/184,343, filed on Jun. 5, 2009.

(51) Int. Cl. G06F 3/048; G06F 17/30

(52) U.S. Cl. 707/748; 707/736; 707/758; 707/760; 709/231; 707/E17.018; 707/E17.101; 707/E17.032

(57) ABSTRACT

The invention pertains to song-related software applications. More specifically, the invention describes mapping songs being listened to in a given area, identifying users listening to those songs, and optionally selecting to follow the songs listened to by a specific second user. The invention allows charting the most popular songs according to geographical location. Additionally, the invention allows a user to select an internet radio station and be provided with the synchronized lyrics of the song playing. The invention allows translation of lyrics into various languages and synchronization of the translation during playback of the song. The invention also allows a user to synchronize subtitles of multimedia presentations, with the playback of the presentation.

### CROSS-REFERENCE TO RELATED APPLICATIONS

The present invention is a continuation in part of international application PCT/IL09/000804, filed on 13 Aug. 2009, and published as WO 2010/018586A2, herein incorporated in its entirety by reference, and which claims priority of the following US provisional patent applications, now abandoned: U.S. Provisional application 61/088,727 filed 14 Aug. 2008, and U.S. Provisional application 61/094,954 filed 7 Sep. 2008, and U.S. Provisional application 61/152,368 filed 13 Feb. 2009, and U.S. Provisional application 61/166,743 filed 5 Apr. 2009, and of U.S. Provisional application 61/184,343 filed 5 Jun. 2009, now abandoned.

### FIELD OF THE INVENTION

The invention pertains to song-related software applications. More specifically, the invention describes mapping songs being listened to in a given area, identifying users listening to those songs, and optionally selecting to follow the songs listened to by a specific second user. The invention allows charting the most popular songs according to geographical location. Additionally, the invention allows a user to select an internet radio station and be provided with the synchronized lyrics of the song playing. Moreover, the invention allows translation of lyrics into various languages and synchronization of the translation during playback of the song. The invention also allows a user to synchronize subtitles of multimedia presentations, with the playback of the presentation.

### BACKGROUND OF THE INVENTION

Sophisticated cellular phones have become popular, with a multitude of capabilities, including internet surfing and media players. Users may download their favorite music along with any accompanying video or still images, and the playback quality and display are impressive enough to give maximum satisfaction.

U.S. Pat. Publication No. 2009/0083281, to the present inventors, disclosed a method and system that allow a user to easily receive song lyrics that are displayed on a user's display screen, in a synchronized manner to the playback of the song. While prior art methods provided lyrics as text, which a user would have to continuously scroll through while the song was playing, U.S. Pat. Publication No. 2009/0083281 provided the lyrics in a line-by-line manner, in synchronization with the phrase being heard. This allowed a user to effortlessly follow the lyrics. If synchronized lyrics were unavailable, the user could synchronize the lyrics himself by tapping on his touch-screen, and the synchronized version would be automatically sent to a database maintained by the inventors, for storage and distribution to future users.

The present invention provides further developments, most of which are related to downloading songs of interest, along with synchronized lyrics.

In past, in order to determine which songs were most popular, it was necessary to follow purchasing trends of music CDs in music stores, or to chart the songs played most frequently on various radio stations. As more music is purchased by downloading digital versions using the internet, one may follow popularity trends in a different manner.

An artist may wish to determine whether he has a fan base at a specific location, in order to plan a concert tour accordingly. Additionally, students may wish to know what music their contemporaries are listening to, and may decide to download these same songs as they discover they have mutual likes and dislikes.

The need exists for software that can readily track what music is being played at various locations at a given time. A user is provided with access to the most popular song results, is allowed to download any songs of interest, along with synchronized lyrics.

The present invention provides such software, and maps the most popular songs upon a geographical map.

These and other objects will become more apparent in the detailed description that follows.

### SUMMARY OF THE INVENTION

The present invention provides a computerized method of providing a user with a music map charting the geographical location of songs presently or recently played, comprising:
receiving a request from a user for a music map for a predetermined location;
collecting data from a plurality of users, the data comprising the identity of songs recently played, the geographical location of the users, and the identity of the users;
preparing a music map depicting the geographic location of the users and depicting the associated data collected;
sending a user the music map.

In one embodiment, the predetermined location is selected from: the vicinity of a user, a selected country, a selected state, worldwide, and a school or university campus.

Optionally, in step (b) the geographical location of the users is determined by collecting data from one of the following: a GPS unit within a user's cellular phone; a user's internet protocol (IP) address, and the cellular tower location to which a user is connected.

In some options, the music map requested in step (a) comprises a request to chart where a selected song is playing or has recently been played.

The identity of the user may comprise one or more of the following contact information: a user's email address, and a user's phone number; thus allowing a first user to contact a second user.

In some embodiments, the map depicting songs recently or currently played, includes one or more links for downloading the songs digitally.

In one embodiment, collecting data from a plurality of users additionally comprises collecting information on an activity a user is performing while listening to a song, and providing the information to a user upon request.

The invention also provides a computerized method of charting the most popular songs, comprising:
collecting data of the identity of a plurality of songs, and the number of times they are downloaded, the data collected from at least one website;
allowing a user to select the popularity parameters;
ranking the popularity of the songs, according the user's selected popularity parameters;
providing a user with the resultant list of songs, charted according to their popularity.

The popularity parameters which a user may select from may optionally be comprised of one or more of the following: songs popular in a specific location; songs popular worldwide; most popular singing artist; and songs played within the past preselected amount of time.

Optionally, the charted list of popular songs comprises at least one link for downloading the songs.

Additionally the invention describes a computerized method of following music listened to by a preselected user of interest, comprising:
allowing a first user to select a second user of interest for music following;
collecting data identifying songs played by the second user into a list;
providing the list to the first user.

Optionally a further step (d) is included, of providing at least a portion of one or more songs from the list to the first user for playback.

In a presently preferred embodiment, the contact information of all users is provided to all other users for social networking.

The invention also discloses a method of providing a user with song lyrics synchronized to an internet radio stream, comprising:
providing a user with a link to one or more internet radio stations;
after a user has selected and tuned to a radio station, identifying the song currently being played on the station;
retrieving the synchronized lyrics for the song from a database of synchronized lyrics;
providing a user with the synchronized lyrics, for display in synchronization with the stream from the internet radio station.

Identifying the song currently being played may be performed using one of the following: using a song ID tag provided digitally by the internet radio station; and using song identification software.

The method may comprise providing a user with a map charting and identifying additional users presently listening to the same radio station as the user, and providing the user with contact information for the additional users.

The invention also discloses a method of providing a user with subtitles synchronized to a multimedia presentation including spoken words, the method comprising:
allowing a user to select a multimedia presentation;
providing a user with written subtitles which are displayed in synchronization to the multimedia presentation; or providing a user with unsynchronized subtitles and requesting a user to indicate the synchronization information using electronic device peripherals and saving the synchronized subtitles in a database.

In certain embodiments, the multimedia presentation is selected from: a speech, a movie, a video clip, a recital, and an audio book.

Moreover, the invention also discloses a method of translating song lyrics, comprising:
providing a user with lyrics phrases of widespread use;
allowing a user to translate the phrases into a language he is familiar with;
saving the translated phrases into a database;
allowing users to query the database to retrieve translation of unknown phrases.

The method may comprise allowing a user to record himself vocalizing the phrases, saving the recordings and providing the recording upon receipt of a translation query.

Still further, the invention provides a computer system comprising a remote server in communication with the internet, the server configured to:
identify users that are listening to songs using playback software of the invention;
identify songs being played by the users;
chart the location of the users upon a geographical map to create a music map, associate the songs being played by the users with their location on the map;
receive a query from a user's electronic device, to obtain a predefined music map; send the music map to a user.

In the computer system, the server may be further configured to chart the most popular songs listened to, according to location; and to provide a chart to a user upon receiving a request from a user.

Optionally, the server is further configured to provide a user with contact information of additional users.

The server may be further configured to receive a request from a first user to follow music listened to by a preselected second user; and provide the first user with information identifying songs listened to by the second user.

Moreover, the system may comprise a remote database, comprising lyrics of songs and associated synchronization information for at least some of the songs, and the system is further configured to:
search in the remote database for the lyrics and associated synchronization information in response to a query from a user; and if both lyrics and associated synchronization information are found in the remote database: to send the lyrics and associated synchronization information when found back to a user's electronic device;
and if lyrics without associated synchronization information are found in the remote database: the remote computer system is configured to send the lyrics to a user's electronic device.

In some options, the system is configured to search the database for a word or phrase in the lyrics in response to a query from a user, and the system is configured to provide a user with the search results.

### BRIEF DESCRIPTION OF THE DRAWINGS

For a better understanding of the invention, with regard to the embodiments described, reference is made to the accompanying drawings, in which:

FIG. 1 and FIG. 2 illustrate screenshots allowing a user to request a music map charting geographically, additional users listening to a specific song.

FIG. 3 illustrates a music map depicting users worldwide listening to a specific song.

FIG. 4A illustrates a music map for the city Belo Horizonto in Brazil, showing various users listening to music.

FIG. 4B illustrates a menu allowing a user to select a location of interest for generating a music map.

FIG. 4C illustrates a music map showing music and other users playing music located near the user.

FIG. 5 illustrates screenshots allowing a user to request a chart of most popular songs or artists and to define the parameters of the search.

FIG. 6 illustrates selecting a country of interest for charting the most popular songs in that country.

FIG. 7 illustrates the results charted for the most popular songs in California; the user may select the time period of interest.

FIG. 8 illustrates the results charted for the most popular songs in China.

FIG. 9 illustrates trend-setters identified upon a music map.

FIG. 10 illustrates identification and details of a trend-setter.

FIG. 11 illustrates a screen listing fans that follow music listened to by a user.

FIG. 12 illustrates a list of songs received in a song-box, representing songs recently listened to by a trend-setter that the user is following.

FIG. 13 shows links to internet radio stations.

FIG. 14 illustrates identifying the song played on an internet radio station, retrieving the synchronized song lyrics from a database, and sending them to a user for display in sync with the stream.

FIG. 15 illustrates a music map showing users listening to a specific song via an internet radio station.

FIG. 16 illustrates a flow chart of language translation process for song lyrics.

FIG. 17 is a screenshot showing a menu including the option to translate song lyrics.

### DETAILED DESCRIPTION OF THE INVENTION

In the following detailed description, numerous specific details are set forth in order to provide a thorough understanding of the present invention. There is no intention to limit the invention to the details of construction and the arrangement of the components set forth in the following description or illustrated in the drawings. The invention is capable of other embodiments or of being practiced or carried out in various ways. Also, it is to be understood that the phraseology and terminology employed herein are for the purpose of description and should not be regarded as limiting.

The present invention provides software applications which may be run by a user on electronic device, such as his cellular phone, PDA, personal computer or laptop. The applications utilize communication channels, to contact a server running the software of the invention, such that the user may send song-related requests and may receive and download the appropriate song or song-related data.

The invention allows a user to connect to a website running the software of the invention, and the user may request to view a map or list, of what songs are being played at any geographical location he selects, in various manners:

A user may request to chart where in the world a specific song is being played. He may ask to show what songs are being played near his own location. He may ask to see the top 10 or top 50 songs ranked according to popularity; optionally the songs may be ranked also according to popularity in a specific city or for instance, a specific university campus. The songs of interest are then made available to a user for downloading, along with the synchronized lyrics.

A first user may receive the identity of other registered users, and may select to follow the music played by one or more other users, after discovering they have similar taste. The songs played by the second user will be made available to the first user.

Additionally, the invention allows a user to tune into an internet radio station, and the software of the invention will automatically identify the song being played and will retrieve and display the lyrics in synch with the song being streamed. When the next song is played, it will similarly be identified and its lyrics will be retrieved and provided to a user.

In the following description and figures, the invention is described as used upon a cellular phone having a media player. This is merely a typical example for use of the applications of the invention and there is no intention to limit the scope of the invention to cellular phones only.

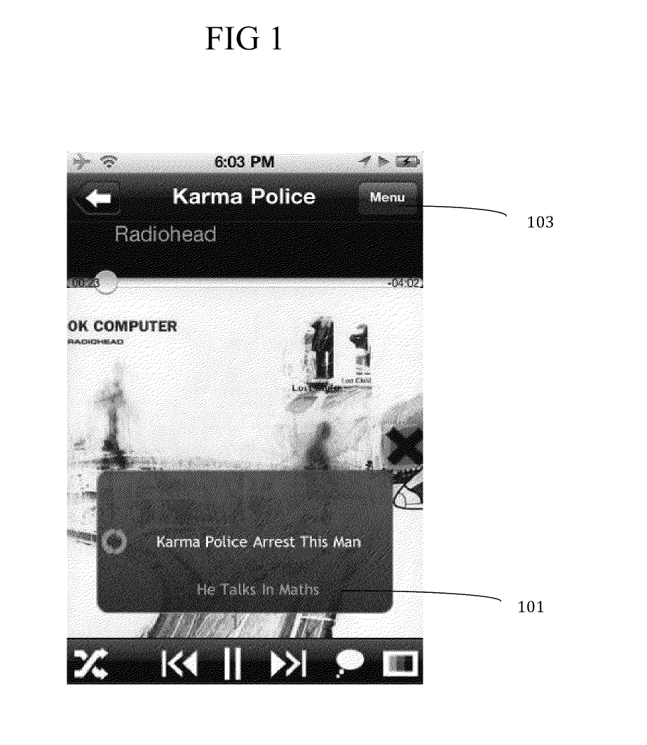

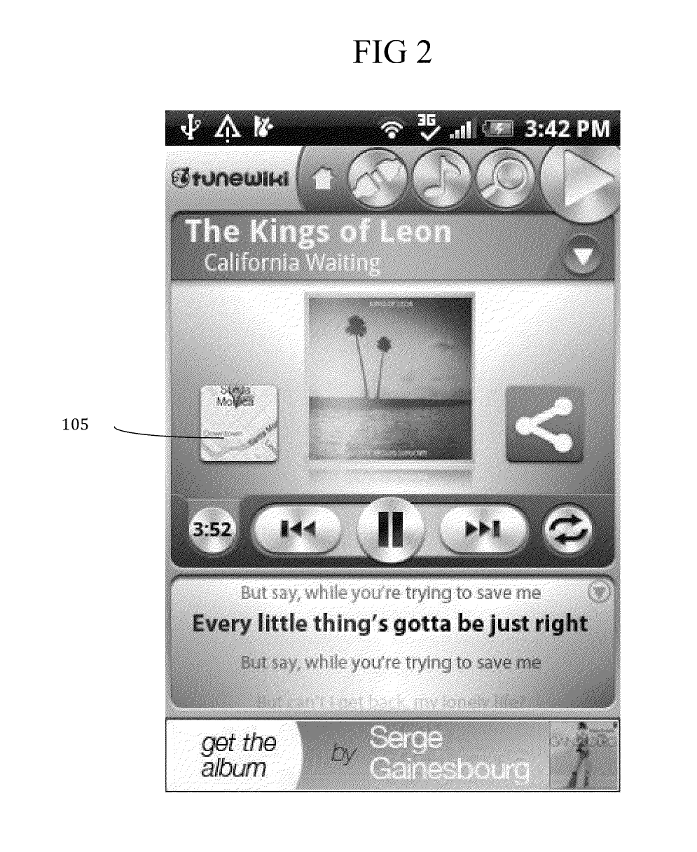

Referring now to FIG. 1, a user has selected a specific song, titled “Karma Police”, sung by the group Radiohead. In this example, the user has previously downloaded this song onto his smart-phone which runs the software of the present invention. The software of the invention has already retrieved the synchronized lyrics, and the first line of the lyrics 101 is displayed at the bottom of the screen (“he talks in maths”). The user may press the Menu button 103, and he receives the screen shown in FIG. 2, which may be used to create a map of other users listening to this song.

Referring to FIG. 2, after selecting a song titled “California Waiting”, sung by the group “The Kings of Leon”, and pressing the Menu button (shown in FIG. 1), the screen shows a Map icon 105, which a user may press to map where in the world this song is playing. In the map icon 105, the present user is identified as being located in Santa Monica.

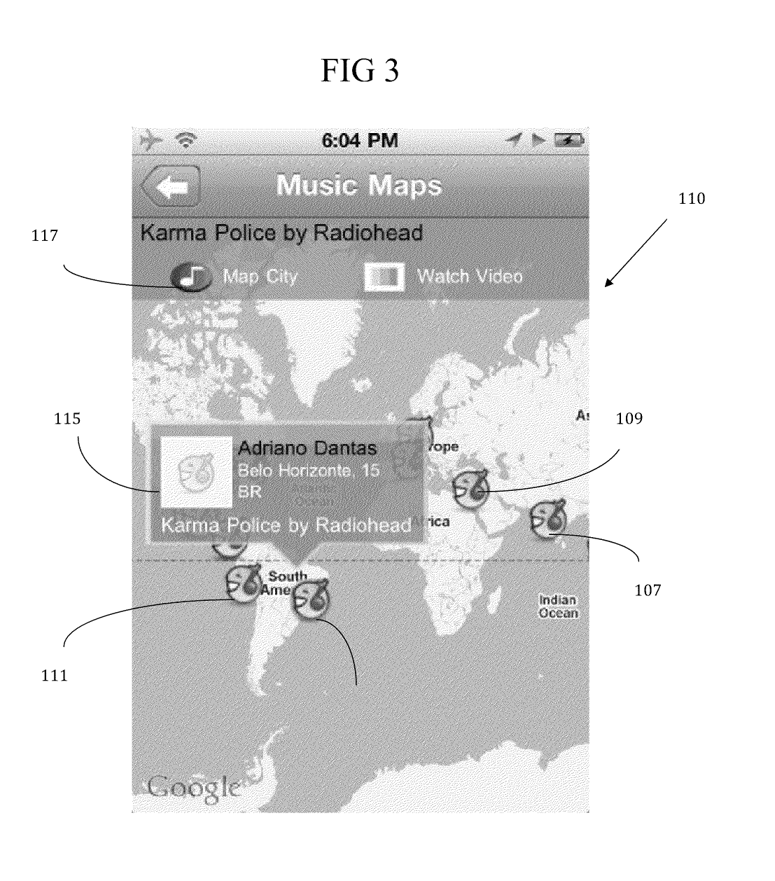

The request to form the map display is sent to a website running the software of the invention, and the resultant “music map” will be returned by the website to the user, as shown in FIG. 3.

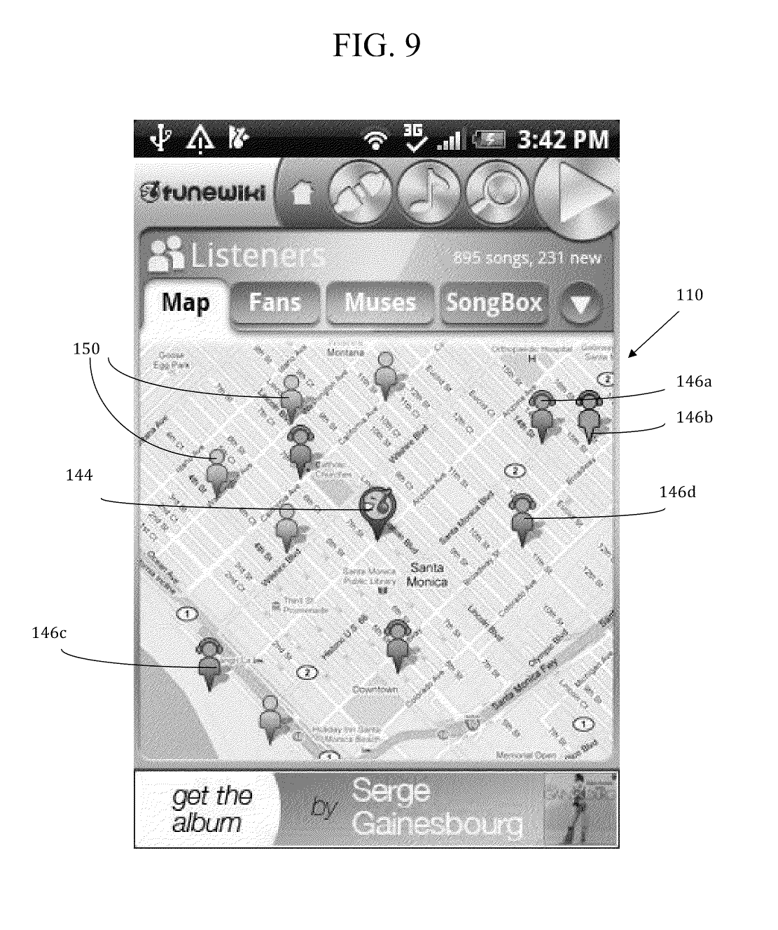

Referring to FIG. 3, the user receives the music map 110 showing other users in the world that are presently listening to the song selected (Karma Police), or that have listened within the last 24 hours to this song. Users 107, 109, 111, 113, 115, are indicated as icons of smiley faces wearing headphones. The user has clicked on a specific icon of another user 115, and has received the identity of the other user, as Adriano Dantas, a 15 year old located in Belo Horizonto, Brazil. Should the user wish, he may follow future music selections of Adriano Dantas, as will be described herein-below in relation to FIGS. 9-12.

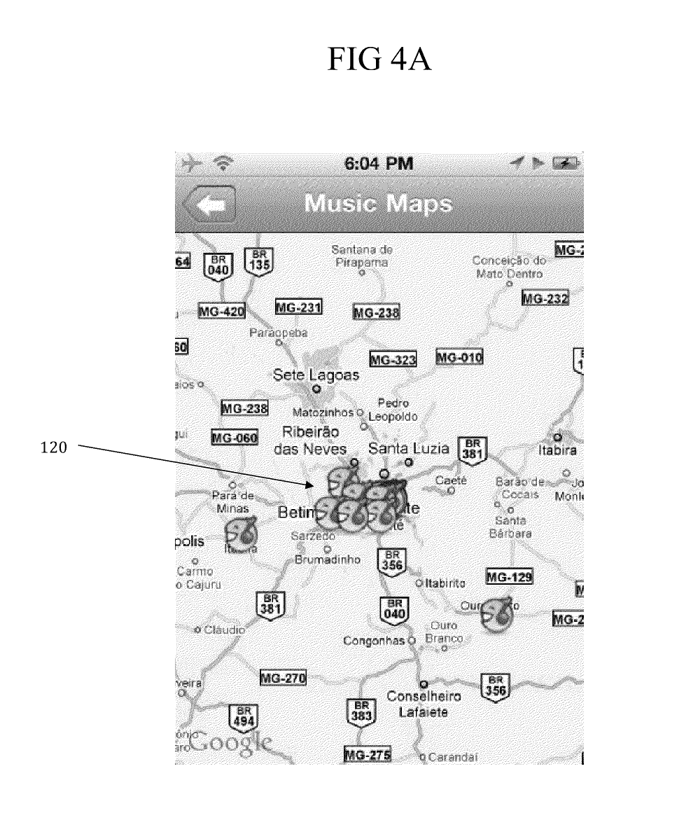

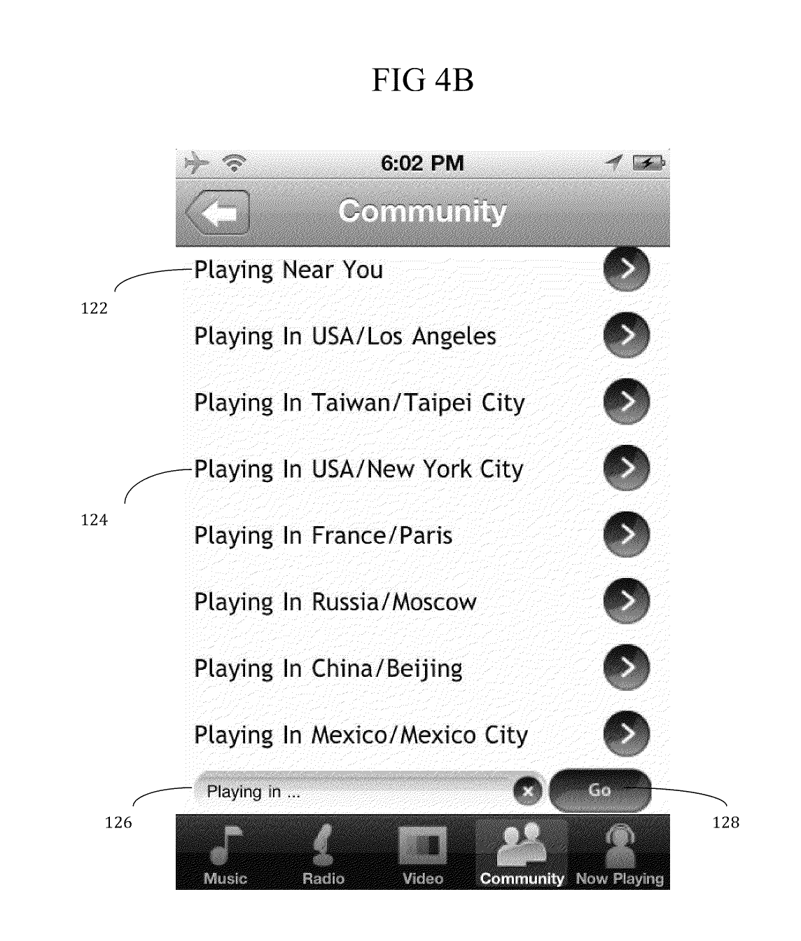

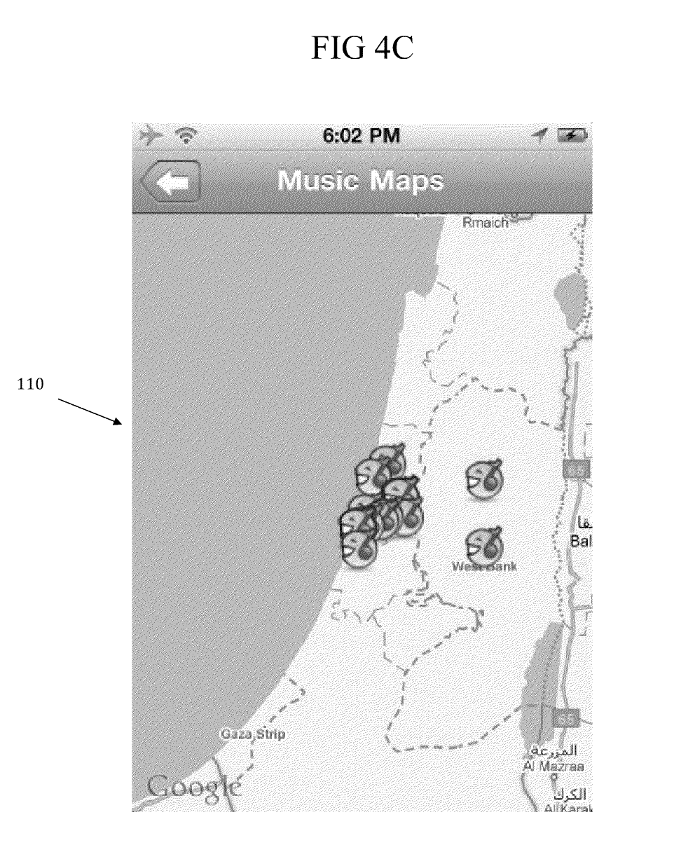

The user may press on the Map City icon 117, which will send a request to the server to chart songs being played in a specific city of interest. The resultant map is returned to the user and displayed on his screen, in FIG. 4.

Referring to FIG. 4A, the map for the city Belo Horizonto in Brazil, is displayed, with various users shown as icons 120.

Referring to FIG. 4B, the user may select any city from a list, and request to form a music map for that city. The user may select the location by pressing on any of the choices shown, such as “playing near you” 120, playing in USA/New York City 124, etc. The user may type in the name of a city not appearing on the list, by selecting “Playing in . . . ” 126, typing in the requested city, and clicking on the “go” button 128. The map request is sent to the server, which instantly provides the user with a geographical map charting users and what music they are listening to.

Referring to FIG. 4C, the user has asked for a map charting music playing near him. The server has identified the user's location as being in Israel, and has mapped users nearby and returned music map 110 to the user.

The physical location of users listening to music using the application of the invention, is obtained and utilized for charting upon a music map, by one of several means. Data may be obtained from the GPS unit within a user's cellular phone, if present. Alternatively, the user's IP address may be utilized to obtain his location, or the cellular tower location data, to which the user is connected, may be used to obtain his location. Locations are typically obtained for users that run the software of the invention.

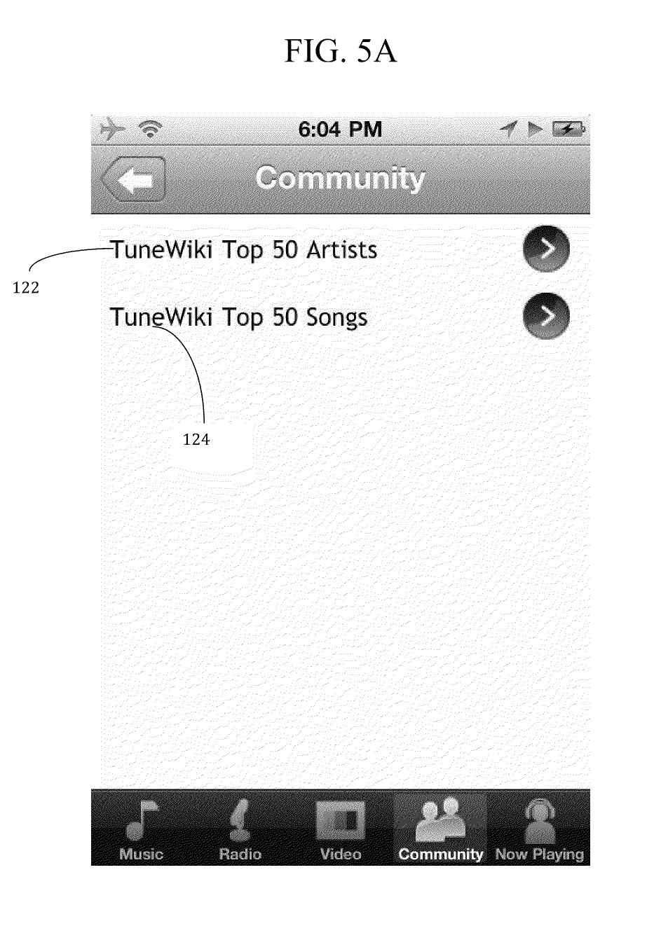

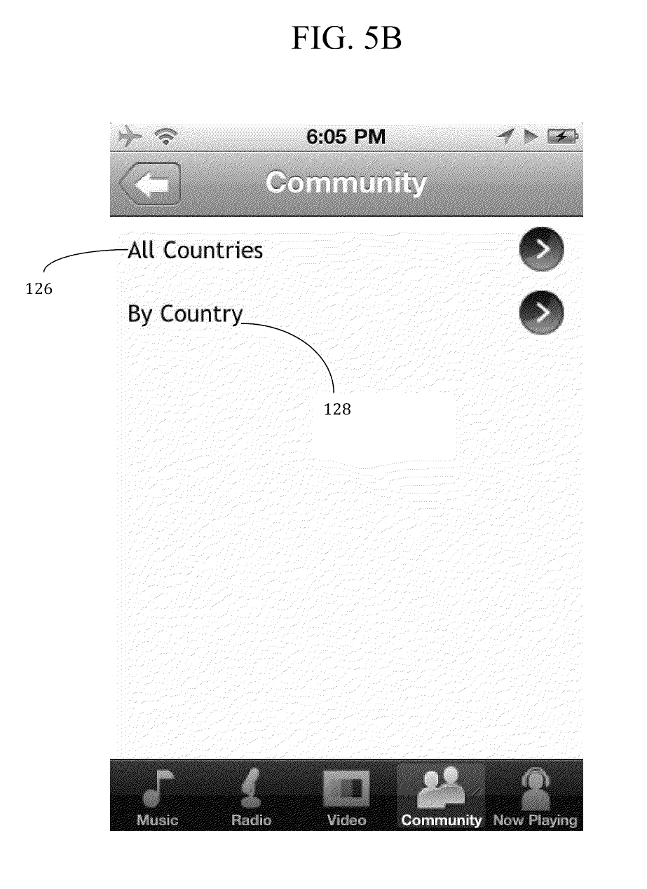

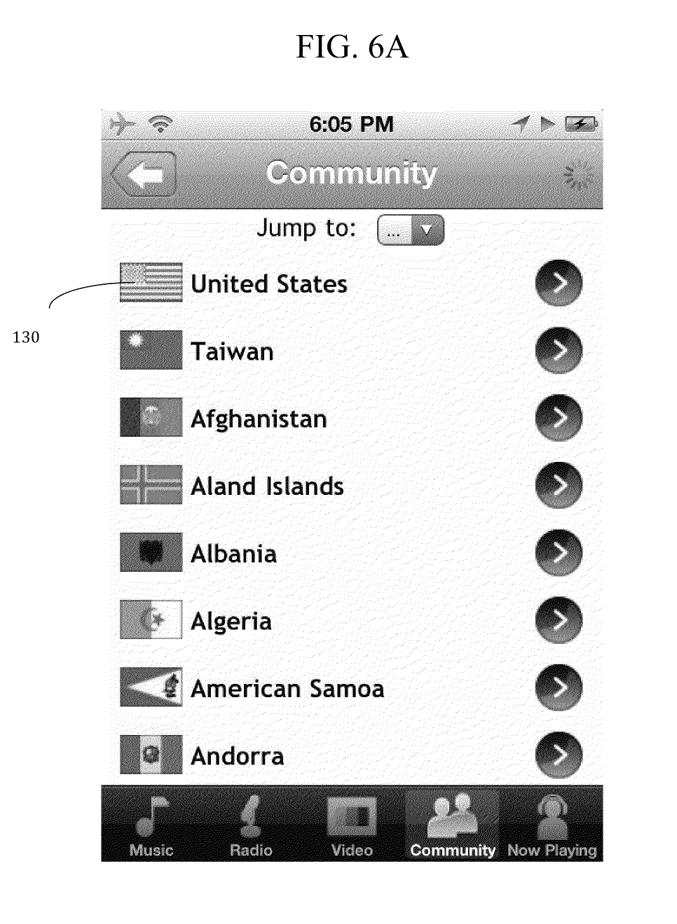

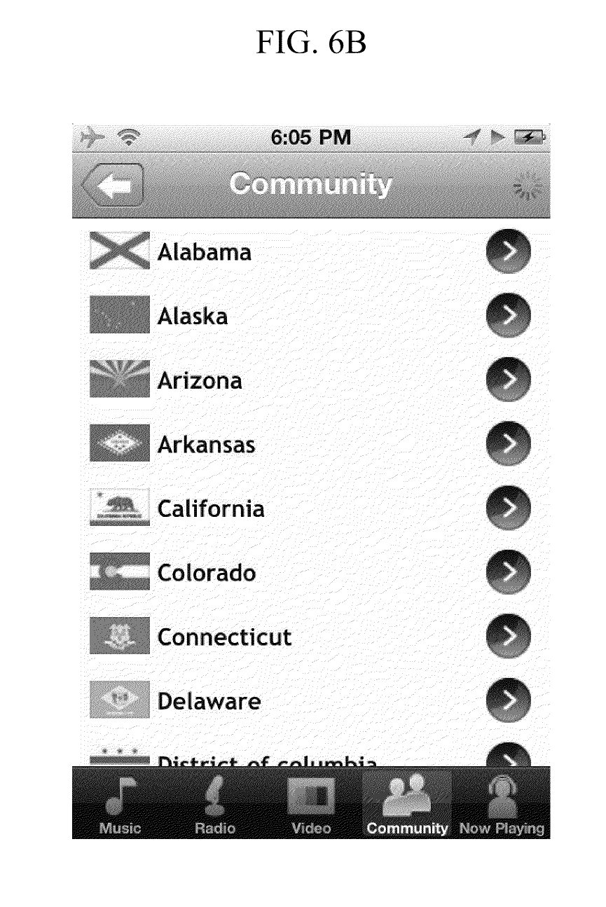

Referring to FIG. 5A, the software of the invention may be used to chart the popularity of various songs. In the screen shown in FIG. 5., a user may select to view either the “top 50 artists” 122, or may select to view the “top 50 songs” 124. The screen shown in FIG. 5B will then appear, asking the user to select whether he wishes to view the top songs as ranked worldwide, in which case he will select “all countries” 126. Alternatively, he may wish to only see songs popular in a specific country, in which case he will select “by country” 128. The screens shown in FIG. 6A, 6B will allow him to then select the country of interest.

Referring to FIG. 6A, the user has requested to view songs charted by popularity, and is asked to select a country of interest. Should he select “United States” 130, the screen in FIG. 6B will appear, asking him to select a specific state of interest.

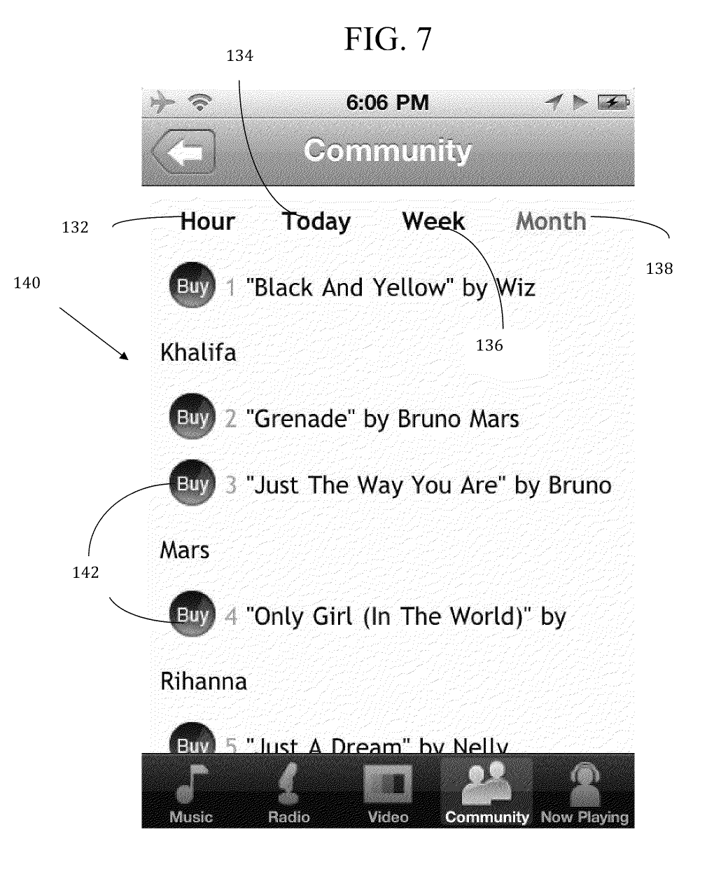

Referring to FIG. 7, the user has asked for the top 50 songs ranked by popularity in the State of California. He may select from header buttons, whether he wishes to view the top 50 songs as ranked within the last hour 132, ranked today 134, ranked within this week 136, or ranked within this past month 138. The top songs are presented in a list 140 showing the name of the song and the artist, and alongside a “Buy” icon 142, allowing the user to purchase and download the song and synchronized lyrics from the database maintained by the inventors.

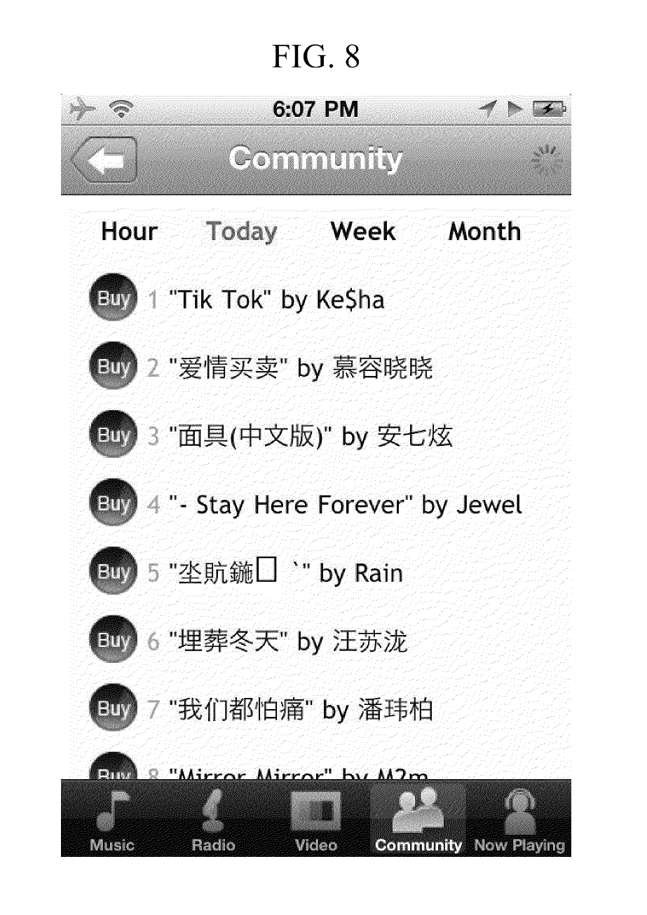

Referring to FIG. 8, the user has requested to view the top 50 songs popular today in China, and has received the list shown in FIG. 8, which includes both foreign songs (e.g. item 1 on the list) and domestic Chinese songs (items 2-7 of the list).

Another central feature of the present invention is to allow a user to follow the music played by other users, who he defines as “trend setters”, as he sees he has similar taste to them and wishes to save music they listen to. Music the trend setter plays or recommends is sent to a “Song-box” of the user. Optionally this occurs in real-time. Optionally a user may view in real-time the amount of time another user dedicates to playing music, thus allowing easy identification of trendsetters, who typically spend more time downloading music than the average population.

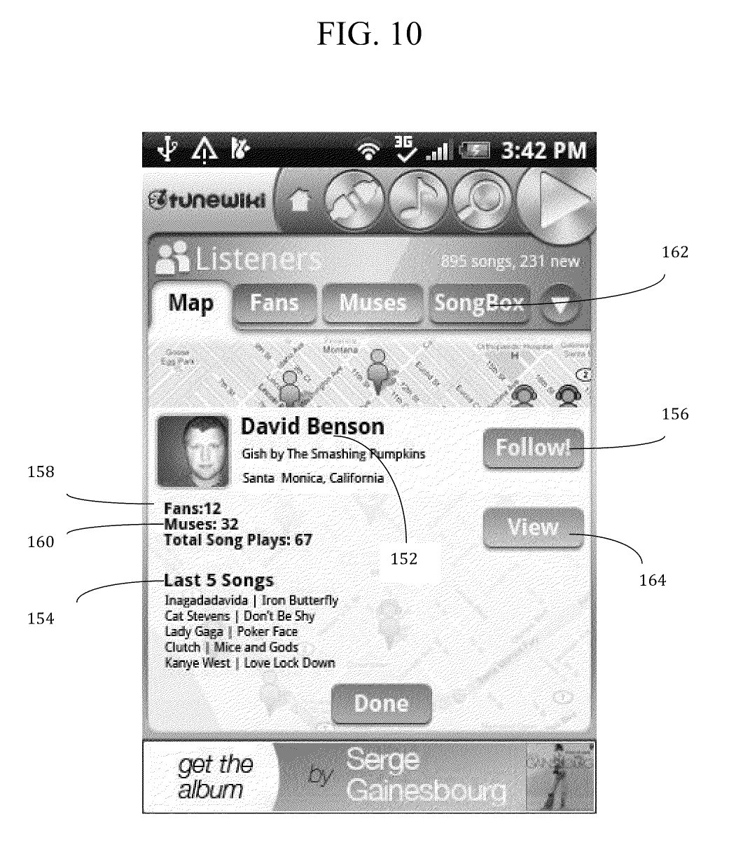

Referring to FIG. 9, trend-setters are identified upon a music map. The user 144 has asked to show a music map 110 showing the geographical location of users playing music near him. Trend-setters 146a, 146b, 146c, 146d are marked as icons wearing headphones, and other users appear as icons of people 150. A user may click on any icon to view the identity of the user, and to view the music he is listening to or has recently heard. The screen shown in FIG. 10 is then opened.

Referring to FIG. 10, as user has clicked on an icon of a trend-setter, and has received the information that the user is identified 152 as David Benson, living in Santa Monica, Calif. and now playing the song “Gish” by The Smashing Pumpkins. The last 5 songs listened to 1564 by the trend-setter are shown. The number of fans 158 that follow this trend-setter is shown to be 12. The user may press the “follow” button 156 to become a follower of this trend-setter, and receive updates on new music listened to by the trend-setter. New music is sent to the user's Songbox 162, either in full-length or as demos of the first few lines of each song.

The user may press the “view” button 164 to see additional details of the trend-setter's songs and hear them played.

The trend-setter himself has marked 32 other users as his “muses” 160, namely they are his trend-setters and he follows music listened to by them.

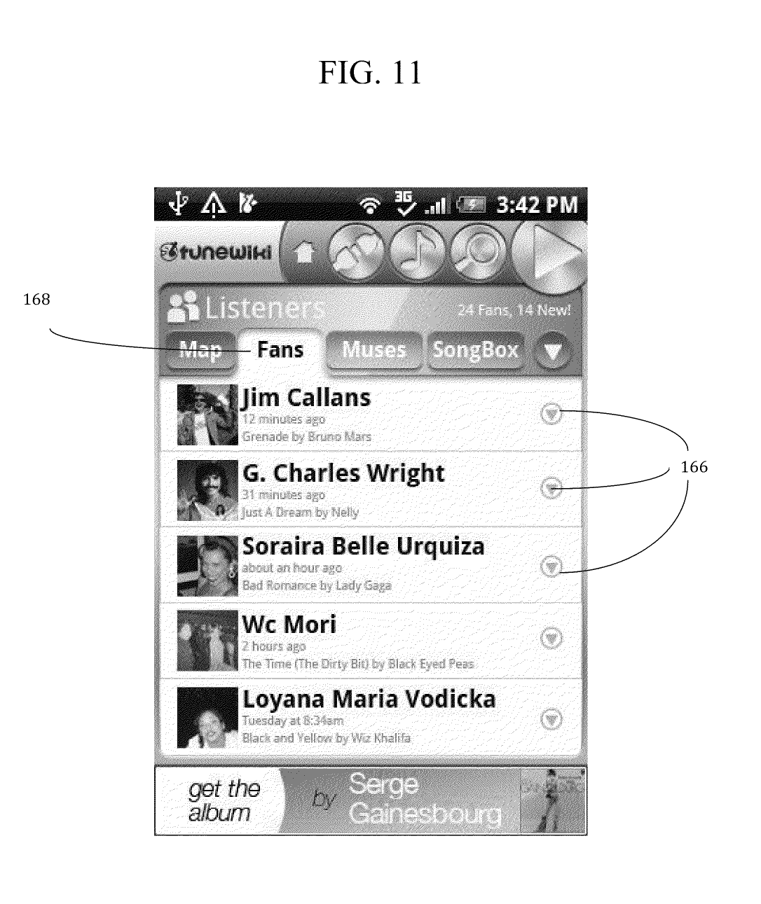

Referring to FIG. 11, a user has pressed the “Fans” tab 168, and has received the identification of all other users that have identified themselves as his fans (naming him their trendsetter). He is also given information on music the fans are listening to. He may contact these users by pressing on the arrows 166 associated with each user name, and may see their additional music choices.

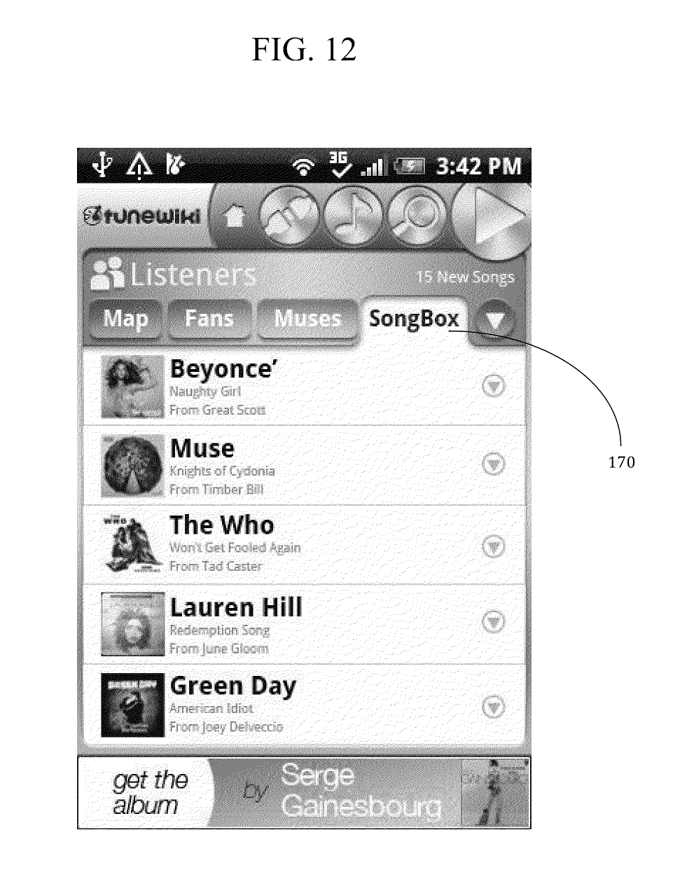

Referring to FIG. 12, the user has pressed the “Songbox” tab 170, and views details of songs which have been listened to by the trend-setters he selected. Clicking on any song will play either a demo or the full-length song; he may purchase the full-length song to save on his cellular device. The user may request to receive only new songs to his Songbox, so that if the trendsetter replays songs, the user will not receive multiple copies of these songs. The user may also request to receive only songs which he has not yet downloaded independently, and the software will check whether a song is already in the user's media player before downloading the song.

In another embodiment, the “follow me” trend-setting capabilities of the invention are made available for detecting and following trend setters and their taste in movie, poetry, books, etc.

Another central feature of the invention, allows a user to tune into an internet radio station, and the software of the invention will automatically identify the song being played and will retrieve and display the lyrics in synch with the song being streamed. When the next song is played, it will similarly be identified and its lyrics will be retrieved and provided to a user.

The identity of the song being played may be determined by the software of the invention, using the ID tag provided by the internet radio station, using available song identifying software, such as that offered by Shazam™ or using identification algorithms of the invention.

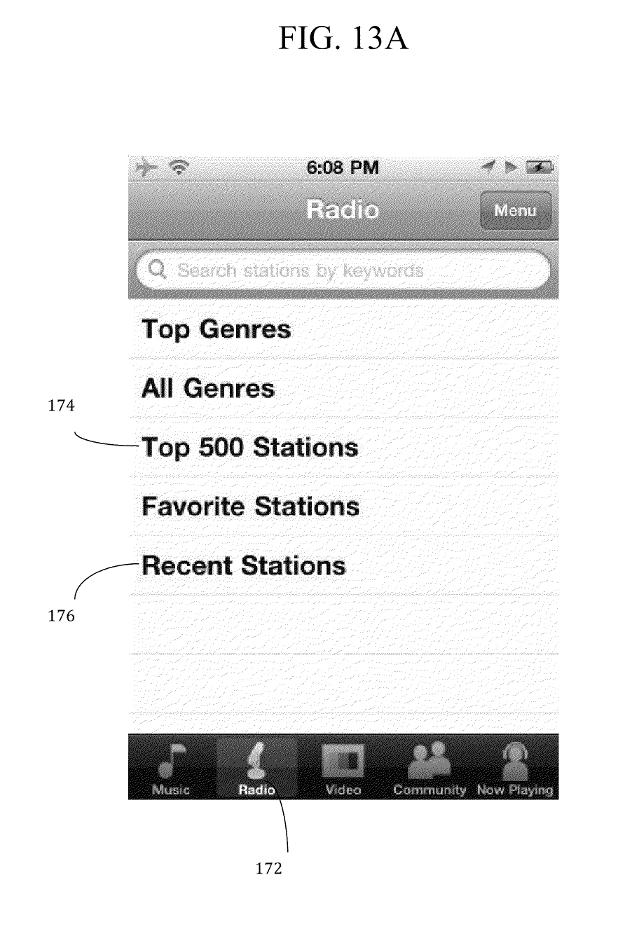

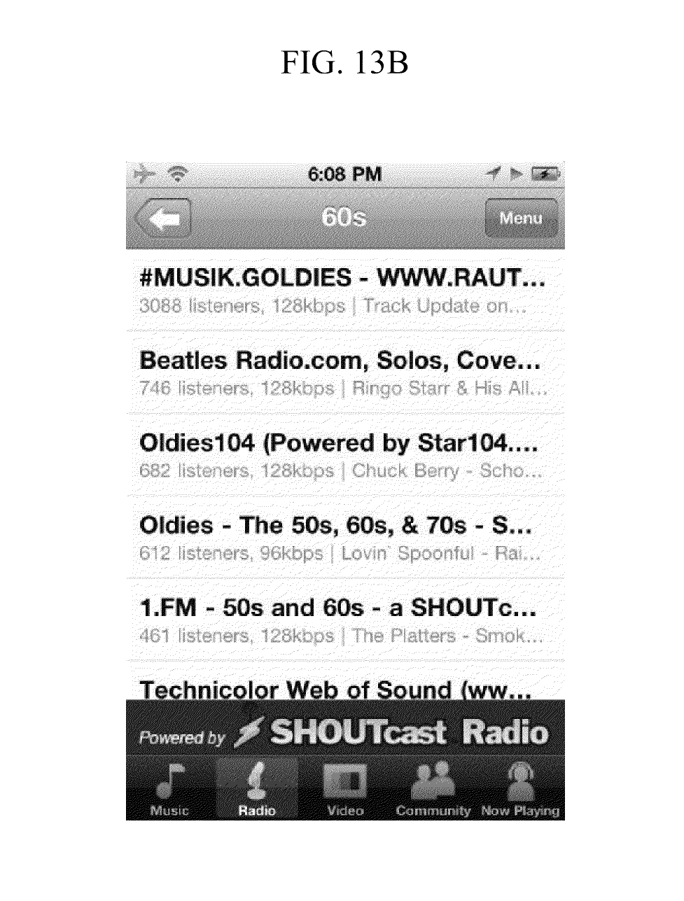

Referring to FIG. 13A, the user has selected the Radio button 172 at the bottom of the screen, and received a menu for selecting an internet radio station. Among his options are the top 500 most popular stations 174, and recent stations 176. After selecting “recent stations” 176, the screen illustrated in FIG. 13B appears, showing various internet radio stations, and the song currently playing on each station.

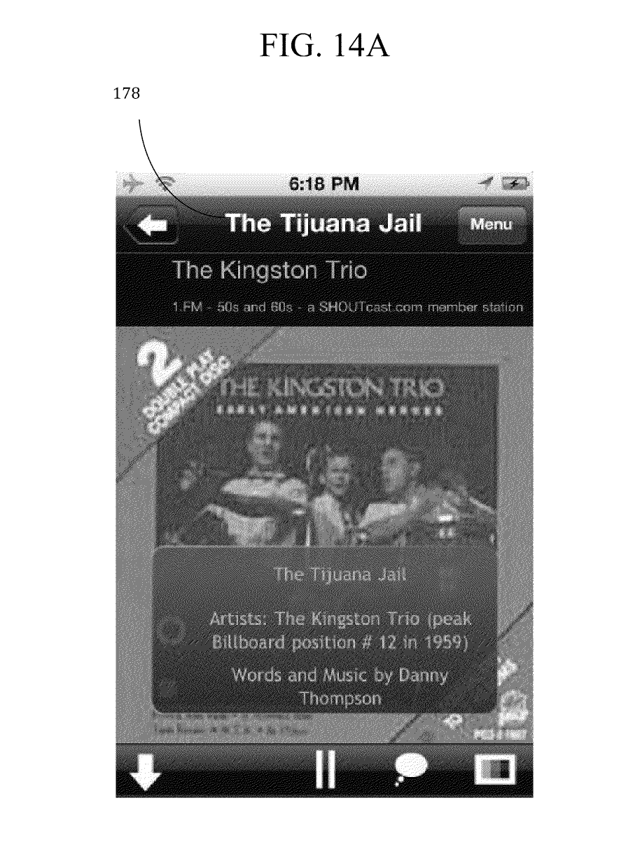

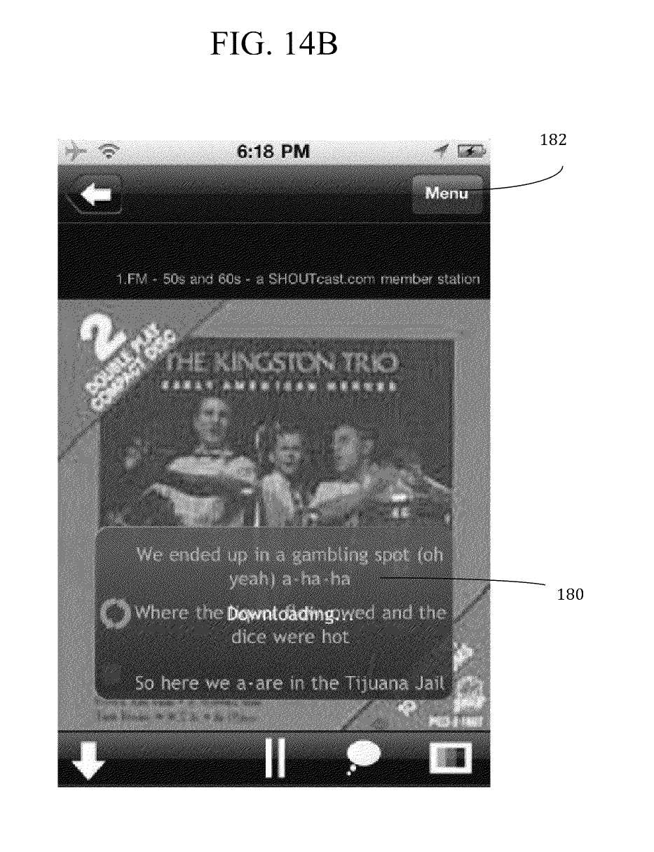

Referring to FIG. 14A, an internet radio station has been selected, and in this case the song ID has been transmitted by the radio station as “The Tijuana Jail” 178 by The

Kingston Trio. The song name is sent to the server running the software of the invention, and a search is performed of the database maintained by the inventors, for the synched lyrics of the song. Referring to FIG. 14B, the synchronized lyrics 180 have been retrieved and are displayed at the bottom of FIG. 14B. The lyrics for the relevant phrase currently being played, are displayed so that they advance automatically to the next line without user intervention, as the song continues playing.

If the user presses the menu button 182 at the top of the screen, he will be shown which other internet radio stations are presently playing this song. He may request a music map showing geographically where other users are located that are listening to this song, or are listening to this internet radio station, and providing their identity (as in FIGS. 2-3). Thus the invention may be used for social networking according to mutual taste in radio stations. Trend-setters may be defined by a user, as described in relation to FIGS. 10-11.

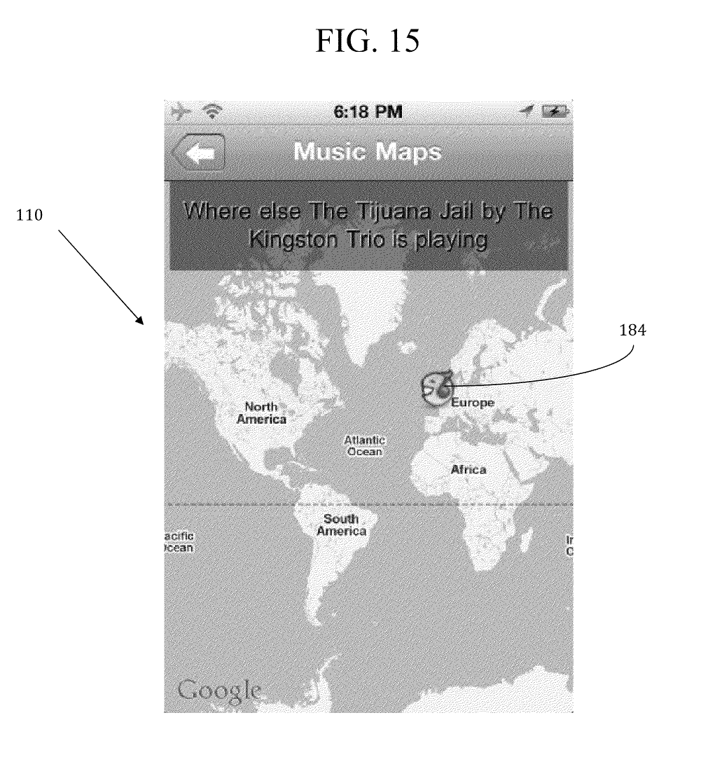

Referring to FIG. 15, a music map 110 has been generated showing users listening to this song via an internet radio station, and a single user 184 has been identified.

After locating a musical selection for a subscriber, the proprietary Web site or software application installed locally on a user's device, can sync lyrics or subtitles to any radio station on the Internet, automatically or semi-automatically. In semi-automatic mode, the exact timing of the song may not be known, as it would be for automatic mode. The timing, in fact, may be completely unknown. Also, a user may typically join the radio stream, not at the beginning of the requested song, but at any point downstream in the song.

Therefore, the subscriber is instructed to manually scroll down through the lyrics that have been retrieved by the Web site, and which are displayed on his mobile phone or other Internet enabled device. Upon locating the line currently playing, the subscriber may, for example tap, double tap, or long tap that line, and from that point on the lyrics scroll forward on the system timer (not on the actual song timer) and the operation functions reasonably well already. The subscriber is further enabled to re-scroll and re-tap on any line of the song to re-adjust the semi automatic sync mode.

This embodiment of the present invention also accommodates non-Internet (standard broadcast) radio. The ID of a particular song is retrieved from a 3^{rd} party song ID services organization, such as yes.com or shazam™. Alternatively, song-recognition software in the form of fingerprinting, watermarking, etc may be used. If timing is available, the song is synched with the tunewiki™ lyrics database of the proprietary Web site (online or offline). If timing is not available from the tunewiki™ lyrics database semi-automatic operation, as described above, is used. The subscriber gets the lyrics, scrolls to the current line, clicks and the sync metadata will take over and complete the async scrolling.

Additionally, this embodiment may be applied not only for song lyrics, but also for synchronizing any form of subtitles, such as for movies, audio books, lectures, famous speeches, poetry recitals, etc. The user scrolls to the line currently being heard/spoken or displayed on the screen, and indicates using electronic device peripherals (such as by tapping on a touch screen or using a mouse or keyboard), where the end of each line of the subtitle being heard is. This forms synching metadata, which is automatically sent to a server and saved in a database maintained by the inventors, for distribution to future users upon request.

In semi-automatic mode, the subtitles are asynched from that point forward. This method applies to any other async sub-titling application, where the device clock is used for timing and not the player clock.

Thus, besides song lyrics, the system is also enabled to add translation, community social networking functions, maps, etc. This includes all other services on prior patents (sync lyrics, translation, social network and so on. The only difference is the music stream does not reside locally.

The method includes choosing a song video by one of the user/subscribers. The method also includes automatically getting a stream of the same video by all user/subscribers and streaming of the lyrics to all of the user/subscribers at the same time, wherein all the participants can see each other on video, can read each other's notes on the text chat and can hear each other sing along with them, and wherein the system uses at least one of multimedia capabilities of the computer comprising: video, sound, mic, chat, playback, and mixers.

The present embodiment provides a method for searching lyrics, or any other textual search, such as a closed caption words database. The search terms are a word or phrase aimed at finding a few digital assets, such as audio or video files that contain the searched word or phrase. When at least one file is found it is extracted and advanced so that playback begins at that exact word or phrase. Because timing information on each of the lines containing the word or phrase, this is easily accomplished.

Of course the same phrase or word might exist in the same song or video more than once, so a ‘next’ button will fast forward the playback to the next timing point where it appears, and naturally ‘fast back’ will take you backwards in the playback.

The features of the present invention include special software ‘one click’ capabilities as follows:

video chat;

music video display;

synched lyrics stream;

instant message;

social network;

music map; and

music charts.

Another embodiment of the present invention includes the following steps and features, to allow several users to synchronize listening to the same song, so they may enjoy it together, and sing along together:

one user/subscriber chooses a song video (from music charts, music map or simple search); all user/subscribers automatically get a stream of the same video;

lyrics stream to all user/subscribers locked into the same timing;

a ‘master’ controls each of the others' players or it can set a ‘lead’ that invites friends to his ‘party’ and only the lead chooses songs and start/stops playback to ‘slaved’ players;

all the participants can see each other on video, can read each other's notes on the text chat and can hear each other sing along with them;

all multimedia capabilities of the computer are utilized: video, sound, mic, chat, playback, mixers and so on; and

an optional embodiment includes a record button to make a replacement soundtrack+the video of the participant, and share it with other friends at the ‘end of the session.’

An alternative of the present embodiment provides for a user/subscriber singing a “duet with himself:”

a single user/subscriber records himself singing said at least one song;

2 videos are stream synched: the recording of the single user/subscriber of himself and one from YouTube;

the single user/subscriber uploads the recording of himself to YouTube; and

both videos are synch streamed at the same time.

This creates the effect of a duet without breaching copyright for a recording of a single of himself ‘cover’ performance.

The software of the invention is operable from any suitable cellular phone, PDA, computer, computer system or related group of computer systems known in the art. In one preferred embodiment, the software is provided to a user as an application upon his cellular phone, laptop or PC. The application can send requests to a remote server or server system upon which the software is installed, and which is connected by at least one input/output port to a communication network. The communication network may be a local area network connecting a plurality of computers via any suitable networking protocol, including but not limited to Ethernet. In another embodiment, the communication network is the Internet and the system comprises server software capable of communicating with client computers or client handheld devices, via the Internet via any suitable protocol, including but not limited to HTTPS. In such case, the invention may be provided to a user as software as a service (SaaS) which will obviate a user from hardware needs such as a server and necessary server maintenance, security, etc. In one embodiment, a user may use a browser such as Internet Explorer™, Mozilla Firefox, Chrome or Safari, to browse on the server via the internet. Any processing device may be utilized, including for instance, a personal computer, a laptop, a PDA or a cellular phone.

The invention is embodied in any suitable programming language or combination of programming languages, including Google Web Toolkit, JAVA, database managers and MyS QL.

Each software component can be implemented in a high-level procedural or object-oriented programming language, or in assembly or machine language if desired. The programming language may be a compiled or interpreted language.

Songs synchronized to lyrics, and music maps, are saved and maintained in a database in one or more servers provided by the inventors. The database may be any suitable database for storing data objects and metadata relating thereto. Any suitable database program may be used. In one embodiment, the database is a relational database and a key/value database. In one embodiment, database is a modified relational database. The search logic used for subsequent retrieval of experiments from the database, is any suitable step, process, function or series of steps, processes and functions known in the art for searching a database.

Each device for running the application of the invention includes a graphical user interface (GUI). The contents of the screens, the functionality of the system and the work process may be adjustable to a user's needs. The screen designs, terms and work process are user-friendly since they display and interact with the user in syntax familiar to him. Thus use of the system appears intuitive.

The invention can be implemented using digital electronic circuitry, or in computer hardware, firmware, software, or in combinations of them.

Suitable processors for implementation of the invention include, by way of example, both general and special purpose microprocessors. Generally, a processor will receive instructions and data from a read-only memory and/or a random access memory.

Generally, a device running the software of the invention will include one or more mass storage devices for storing data files; such devices include magnetic disks, such as internal hard disks and removable disks; magneto-optical disks; and optical disks. Storage devices suitable for tangibly embodying computer program instructions and data include all forms of non-volatile memory, including by way of example semiconductor memory devices, such as EPROM, EPROM, and flash memory devices; magnetic disks such as internal hard disks and removable disks; magneto-optical disks; and CD-ROM disks.

The invention also provides a software method for language translation and access to song lyrics by a plurality of users to a Website that provides a database containing synchronization timing tables utilizing synchronization of music and lyrics playback. The method includes the subscribers accessing a set of original lines in a language Wiki for a song in English or any other language of origin, filling in the language translation word by word and/or phrase by phrase by one of the Wiki subscribers to a second language and vocally recording each of the lines in the second language, thereby providing an automatic language lesson to any language from any language that has been translated.

Table I is a translation table.

TABLE I

| English | Spanish | French | Hebrew | Japanese |
|---|---|---|---|---|
| I | Yo | Je | [symbol] | |
| My | ma | mon | [symbol] | |
| My name is | Me llamo | Je m'appel | [symbol] | |
| I love you | . . . te amo | Je t'aime | [symbol] | |
| Go home | . . . ir a casa | Allez au maison | [symbol] | |

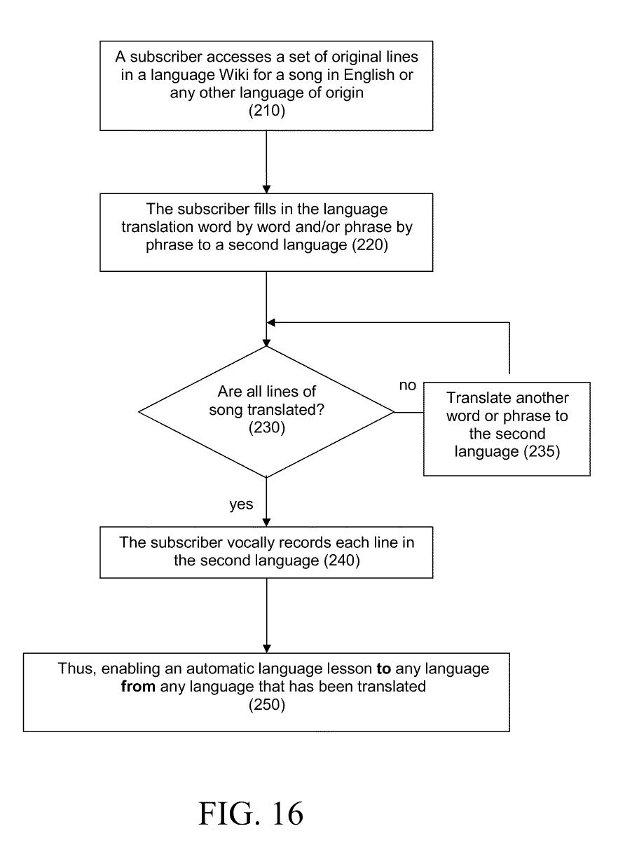

Referring to FIG. 16, a flow chart is shown of the language translation process of the invention for songs. In the language wiki, there will be a set of original sentences for a song in English. The wiki subscribers will fill in the translation to another language, according to the English original. The wiki subscribers will vocally record each line in the other language.

The program now can automatically set up a language lesson to any language from any language. For example, if you want to do a lesson of Hebrew to Japanese, one can match the translation based on the table, cut and paste the text and voice and automatically prepare an MP3 file that will have Hebrew to Japanese or Japanese to Hebrew Format.

Language translation and access to song lyrics is enabled for users accessing a Wiki Web site that provides a database containing synchronization timing tables utilizing synchronization of music and lyrics playback. A subscriber accesses a set of original lines in a language Wild for a song in English or any other language of origin 210. The subscriber fills in the language translation, word by word and/or phrase by phrase, to a second language 220. If all the lines of the song are not translated 230, another word or phrase is translated to the second language 235. If all the lines of the song are translated 230, the subscriber vocally records each line in the second language 240, thus enabling an automatic language lesson to any language from any language that has been previously translated 250.

With enough sentences, a translation application enables the subscriber to look for translations in his/her language and receive the desired translation in text and in voice.

Optionally, the translation database and translation software may be provided to a user for use on his personal electronic device (PC, cellular phone, etc), without necessitating communication with an external website.

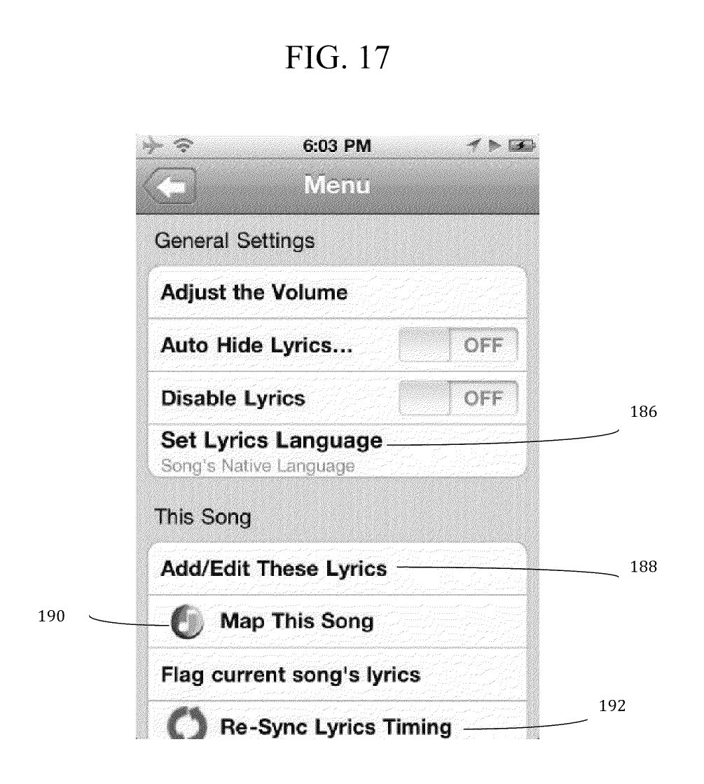

Referring now to FIG. 17, a user may click on “set lyrics language” 186, to receive a translation of the lyrics into a language of his choice, using the translation principles described above. Other non-related options appearing on this screen include the option to edit the lyrics 188 in case of typographical errors, the “map this song” option 190 (for preparing a music map as described in relation to FIGS. 1-4), and the option to “re-sync the lyrics timing” 192.

Another feature of the invention allows a user to perform a Search based on synch:

After a song is synched the text in the line can be searched and the system returns a time code indicating where in the audio or video the text was found. Thus, the system can return the exact location of the text in the audio or video file.

Subscribers can click and find what they were looking for at the exact location and do not need to hear the audio or watch the video from the start. Using sync information from audio to synch video:

The present invention can take the timing information gathered in audio format and use it to sync a video containing the same music or MP3 file.

Charts Based on Activity:

Through a subscriber interface Tunewiki subscribers can specify their current activity and charts will be built based on various groupings of people performing the same activities:

### EXAMPLES

Top 50 people reading and listening to music;

Top 50 people running and listening to music;

Top 50 people cooking and listening to music;

Top 50 people walking and listening to music;

Top 50 people biking and listening to music; and

Top 50 people homesick and listening to music.

TuneWiki for Sport Activities:

Many music lovers listen to their music while jogging. With the spread of global positioning systems (GPS) in handheld units, the subscriber can receive location, speed and or distance information while listening to the music and with relation to the time frames of the music being played.

For example, while jogging and listening to music, the plug-in player module will provide a voice overlay to “tell” the jogger: “you are running at x miles per hours . . . you ran 3.2 miles since the start.”

Or when a new song begins the system will say: “You will cover 1.2 miles if you jog at the same pace you are running at now,” or “You burned xx calories since you started running.”

The community aspect will also be voice activated by the subscriber/jogger: “runners around you are listening to . . . ”The runner approaching you, now 1 mile ahead, is listening to xxxx, to listen to his song press . . . ”

In another exemplary embodiment, the present invention provides a method to enable a plurality of subscribers to play music produced by a particular musical artist of their choice on a music player dedicated to the artist. The method includes bundling a number of songs, lyrics, albums, CD's, videos exclusively by each artist into a music player dedicated to each artist and choosing by subscribers of a musical artist to whom their music players will be dedicated. The method also includes displaying on the screen of each player, a listing of the bundled of the dedicated artist and selecting and playing songs from the list. The method includes enabling the artist to communicate directly with the portion of the subscribers who have dedicated their player to him and to communicate directly with subscribers who have through their twitter, facebook or myspace accounts or a special messaging system in the player. Finally, the method includes participating by the subscribers in a social network dedicated to the artist and locating subscribers on music maps and enabling the managers to plan activities.

This will create an instant social network of the artist within the player. The player will have the rest of the artist songs in 30 sec. trial and buy mode. The files in the player will be exportable to other player including a tunewiki player.

It should be apparent that many modifications, substitutions, changes, and equivalents might occur to those of ordinary skill in the art.

Having described the invention with regard to certain specific embodiments thereof, it is to be understood that the description is not meant as a limitation, as further modifications will now become apparent to those skilled in the art, and it is intended to cover such modifications as are within the scope of the appended claims.

1. A computerized method of providing a user with a music map charting the geographical location of songs presently or recently played, comprising:
a) receiving a request from a user for a music map for a predetermined location;
b) collecting data from a plurality of users, said data comprising the identity of songs recently played, the geographical location of said users, and the identity of said users;
c) preparing a music map depicting the geographic location of said users and depicting said associated data collected;
d) sending a user said music map.

2. The method of claim 1, wherein in step (a) said predetermined location is selected from: the vicinity of a user, a selected country, a selected state, worldwide, and a school or university campus.

3. The method of claim 1, wherein in said step (b) the geographical location of said users is determined by collecting data from one of the following: a GPS unit within a user's cellular phone; a user's internet protocol (IP) address, and the cellular tower location to which a user is connected.

4. The method of claim 1, wherein said music map requested in step (a) comprises a request to chart where a selected song is playing or has recently been played.

5. The method of claim 1, wherein in step (b) said identity of said user comprises one or more of the following contact information: a user's email address, and a user's phone number; thus allowing a first user to contact a second user.

6. The method of claim 1, wherein said music map depicting songs recently or currently played, includes one or more links for downloading said songs digitally.

7. The method of claim 1, wherein said step (b) of collecting data from a plurality of users additionally comprises collecting information on an activity a user is performing while listening to a song, and providing said information to a user upon request.

8. A computerized method of charting the most popular songs, comprising:
a) collecting data of the identity of a plurality of songs, and the number of times they are downloaded, said data collected from at least one website;
b) allowing a user to select the popularity parameters;
c) ranking the popularity of said songs, according said user's selected popularity parameters;
d) providing a user with the resultant list of songs, charted according to their popularity.

9. The method of claim 8, wherein said popularity parameters which a user may select from, are comprised of at least one of the following: songs popular in a specific location; songs popular worldwide; most popular singing artist; and songs played within the past preselected amount of time.

10. The method of claim 8, wherein said charted list of popular songs, comprises at least one link for downloading said songs.

11. A computerized method of following music listened to by a preselected user of interest, comprising:
a) allowing a first user to select a second user of interest for music following;
b) collecting data identifying songs played by said second user into a list;
c) providing said list to said first user.

12. The method of claim 11, further comprising a step (d) of providing at least a portion of one or more songs from said list to said first user for playback.

13. The method of claim 11, wherein the contact information of all users is provided to all other users for social networking.

14. A method of providing a user with song lyrics synchronized to an internet radio stream, comprising:
a) providing a user with a link to one or more internet radio stations;
b) after a user has selected and tuned to a radio station, identifying the song currently being played on said station;
c) retrieving the synchronized lyrics for said song from a database of synchronized lyrics;
d) providing a user with said synchronized lyrics, for display in synchronization with the stream from said internet radio station.

15. The method of claim 14, wherein said step (b) of identifying the song currently being played is performed using one of the following: using a song ID tag provided digitally by said internet radio station; and using song identification software.

16. The method of claim 14, further comprising providing a user with a map charting and identifying additional users presently listening to the same radio station as the user, and providing said user with contact information for said additional users.

17. A method of providing a user with subtitles synchronized to a multimedia presentation including spoken words, said method comprising:
a) allowing a user to select a multimedia presentation;
b) providing a user with written subtitles which are displayed in synchronization to said multimedia presentation; or providing a user with unsynchronized subtitles and requesting a user to indicate the synchronization information using electronic device peripherals and saving said synchronized subtitles in a database.

18. The method of claim 17, wherein said multimedia presentation is selected from: a speech, a movie, a video clip, a recital, and an audio book.

19. A method of translating song lyrics, comprising:
a) providing a user with lyrics phrases of widespread use;
b) allowing a user to translate said phrases into a language he is familiar with;
c) saving said translated phrases into a database;
d) allowing users to query said database to retrieve translation of unknown phrases.

20. The method of claim 19, further comprising allowing a user to record himself vocalizing said phrases, saving said recordings and providing said recording upon receipt of a translation query.

21. A computer system comprising a remote server in communication with the internet, said server configured to:
identify users that are listening to songs using playback software of the invention;
identify songs being played by said users;
chart the location of said users upon a geographical map to create a music map, associate the songs being played by said users with their location on said map;
receive a query from a user's electronic device, to obtain a predefined music map;
send said music map to a user.

22. The computer system of claim 21, said server further configured to chart the most popular songs listened to, according to location; and to provide a chart to a user upon receiving a request from a user.

23. The computer system of claim 21, said server further configured to provide a user with contact information of additional users.

24. The computer system of claim 21, said server further configured to receive a request from a first user to follow music listened to by a preselected second user; and provide said first user with information identifying songs listened to by said second user.

25. The computer system of claim 21, said system comprising a remote database, the remote database comprising lyrics of songs and associated synchronization information for at least some of the songs, and said system is further configured to search in the remote database for the lyrics and associated synchronization information in response to a query from a user; and if both lyrics and associated synchronization information are found in the remote database: to send the lyrics and associated synchronization information when found back to a user's electronic device;
and if lyrics without associated synchronization information are found in the remote database: the remote computer system is configured to send the lyrics to a user's electronic device.

26. The system of claim 25, wherein said system is configured to search said database for a word or phrase in said lyrics in response to a query from a user, and said system is configured to provide a user with said search results.

27. A method for allowing several remote users to listen synchronously to a single song, comprising:
a) allowing a first user to select a song; and to identify additional users;
b) streaming said song and optionally streaming lyrics of said song, to said first user and to said identified users in a synchronized manner;
c) allowing said first user and said identified users to communicate with one another via internet communication means, while said song is playing.
